(19) United States
(12) Patent Application Publication
(10) Pub. No.: US 2006/0286355 A1
(43) Pub. Date: Dec. 21, 2006

(54) Drive recordable master media

(75) Inventor: Jathan D. Edwards, Afton, MN (US)

Correspondence Address: Attn: Eric D. Levinson;Imation Corp., Legal Affairs, P.O. Box 64898, St. Paul, MN, 55164-0898, US

(73) Assignee: Imation Corp.

(21) Appl. No.: 11/154,062

(22) Filed: Jun. 15, 2005

(51) Int. Cl. B41M 5/00

(52) U.S. Cl. 428/195.1

(57) ABSTRACT

Mastering techniques are described that utilize drive recordable master media to generate low-cost, high-resolution masters. A master medium comprises a preformatted substrate layer that includes tracking features, e.g., grooves and lands, and a developable layer formed over the preformatted substrate layer. The developable layer may comprise a phase-change material, a thin film transition metal, or a metal oxide. A conventional mastering bench may be used to define the precise tracking features included on the preformatted substrate layer. The techniques include inserting the master medium into a recording drive capable of accurately following the tracking features. The recording drive alters regions of the developable layer along the tracking features. The master medium is then removed from the recording drive and the altered regions are developed to define a surface pattern on the master medium. A replication process then creates a plurality of data storage media from the master medium.

### TECHNICAL FIELD

The invention relates to manufacturing techniques for creation of optical data storage disks.

### BACKGROUND

Optical data storage disks have gained widespread acceptance for the storage, distribution and retrieval of large volumes of information. Optical data storage disks include, for example, audio CD (compact disc), CD-R (CD-recordable), CD-RW (CD-rewritable) CD-ROM (CD-read only memory), DVD (digital versatile disk or digital video disk), DVD-RAM (DVD-random access memory), and various other types of writable or rewriteable media, such as magneto-optical (MO) disks, phase-change optical disks, and others. Some newer formats for optical data storage disks are progressing toward smaller disk sizes and increased data storage density. For example, some new media formats boast improved track pitches and increased storage density using blue-wavelength lasers for data readout and/or data recording.

Optical data storage disks are typically produced by first making a data storage disk master that has a surface pattern that represents encoded data on the master surface. The surface pattern, for instance, may be a collection of grooves or other features that define master pits and master lands, e.g., typically arranged in either a spiral or concentric manner. The master is typically not suitable as a mass replication surface with the master features defined within an etched photoresist layer formed over a master substrate.

After creating a suitable master, that master can be used to make a stamper, which is less fragile than the master. The stamper is typically formed of electroplated metal or a hard plastic material, and has a surface pattern that is the inverse of the surface pattern encoded on the master. An injection mold can use the stamper to facilitate the creation of large quantities of replica disks. Also, photopolymer replication processes, such as rolling bead processes, can use the stampers to fabricate replica disks. In any case, each replica disk may contain the data and tracking information that was originally encoded on the master surface. The replica disks can be coated with a reflective layer and/or a phase-change layer, and are often sealed with an additional protective layer.

In some cases, the surface pattern encoded on the data storage disk master represents an inverse of the desired replica disk pattern. In those cases, the master is typically used to create a first-generation stamper, which is in turn used to create a second-generation stamper. The second-generation stamper, then, can be used to create replica disks that contain an inverse of the surface pattern encoded on the master. Creating multiple generations of stampers can also allow for improved replica disk productivity from a single data storage disk master.

The mastering process commonly uses a photolithographic process to define the master surface pattern. To facilitate the mastering process, an optically flat master substrate is coated with a layer of photoresist. A tightly focused laser beam passes over the photoresist-coated substrate to expose grooves or other latent features in the photoresist, which may be categorized as a direct-write photolithographic technique. The focused beam may also be modulated or wobbled to define information such as encoded data, tracking servos, or the like, within the features of the master disk. After exposing the photoresist, a developer solution removes either the exposed or unexposed photoresist, depending on whether a positive or negative photoresist material is used. In this development step, the latent exposure pattern is manifest as a topographical master pattern.

Inorganic materials have been proposed as a “dry-resist” alternative to conventional photoresist materials for increased patterning resolutions. For example, phase transition mastering (PTM) has been shown to make blue disk density recordings at greater than 25 gigabyte (GB), pushing beyond even deep ultra-violet (DUV)/photoresist mastering processes. The amorphous and crystalline regions of a phase-change recording layer develop at differing rates and may substantially reduce the number of steps in the mastering process. A PTM system includes the necessary substrate handling, rotary air bearing, beam wobble, and precision translation of a conventional mastering bench, but is designed to record finer resolution marks on a phase-change layer rather than onto a photoresist layer.

### SUMMARY

In general, the invention is directed to mastering techniques that utilize drive recordable master media to generate low cost, high resolution masters. A master medium comprises a preformatted substrate layer that includes tracking features, e.g., grooves and lands, and a developable layer formed over the preformatted substrate layer. The developable layer may comprise a phase-change material, a thin film transition metal, or a metal oxide. The developable layer provides improved resolutions relative to a conventional photoresist layer. In some embodiments, the developable layer may be included in a multi-layer thin film stack designed to enhance recordability.

The techniques described herein include inserting a master medium into a recording drive capable of accurately following the tracking features. The recording drive may include an objective lens to focus a light onto the developable layer to alter regions of the developable layer along the tracking features. The master medium is then removed from the recording drive and the altered regions of the developable layer are developed to define a surface pattern on the master medium. A replication process may then create a plurality of data storage media using a stamper formed from the patterned master medium, i.e., the master.

A conventional mastering bench may be used to define the precise tracking features included on the preformatted substrate layer. In this way, the inherent ability of the recording drive to follow the tracking features may be utilized to achieve a high resolution surface pattern. The recording drives may comprise conventional optical disk recording drives, such as CD, DVD, or blue disk recording drives. Blue disk drives, i.e., disk drives that contain a blue-laser drive head, comprise especially accurate track following capabilities.

As used herein, the term blue disk refers to optical disk media having a data storage capacity of greater than 15 gigabyte (GB) per data storage layer of the disk. Examples of blue disk media include Blu-Ray and HD-DVD, but other future generations of optical disks may also comprise blue disks. In some cases, the master medium may conform to a blue disk standard form factor. For example, the master medium may include a cover layer releasably bonded to the developable layer. In that case, the objective lens within the recording drive focuses the light onto the developable layer through the releasable cover layer. The releasable cover layer is then removed prior to developing the altered regions of the developable layer. In other embodiments, the master medium may be cover-less and the objective lens within the recording drive focuses the light onto the developable layer through a cover layer affixed adjacent the objective lens.

Contrary to conventional mastering techniques that may create approximately ten different masters on a mastering bench each day, the techniques described herein can generate an essentially limitless number of different masters. A conventional mastering bench may define precision tracking features on a pre-master medium, i.e., a first generation master, used to create a plurality of preformatted substrates. Each of the plurality of preformatted substrates is coated with at least one developable layer to form a plurality of master media. A plurality of recording drives can then simultaneously define different surface patterns on the master media to create a plurality of different masters, i.e., second generation masters.

In one embodiment, the invention is directed to a master medium that defines a surface pattern, the master medium comprising a preformatted substrate layer including tracking features, such as grooves and lands, and at least one developable layer formed over the preformatted substrate layer. The at least one developable layer is altered along the tracking features and developed to define the surface pattern.

In another embodiment, the invention is directed to a method of mastering a master medium, wherein the master medium comprises a preformatted substrate layer including tracking features, and at least one developable layer formed over the preformatted substrate layer. The method comprises following the tracking features on the preformatted substrate, altering regions of the at least one developable layer along the tracking features, and developing the altered regions of the at least one developable layer to define a surface pattern on the master medium. Developing the altered regions may comprise applying a solution, such as diluted NaOH, or a vacuum removal process, such as a Reactive Ion Etch (RIE) process, to the developable layer.

In another embodiment, the invention is directed to a method comprising defining tracking features on a pre-master medium to form a first generation master, creating a first stamper from the first generation master, creating a plurality of preformatted substrates that include the tracking features from the first stamper, forming at least one developable layer over each of the plurality of preformatted substrates to form a plurality of master media, defining surface patterns on the plurality of master media to form a plurality of second generation masters, creating a set of second stampers from the plurality of second generation masters, and creating a plurality of data storage media from the second stampers.

The invention may be capable of providing one or more advantages. For example, the invention substantially reduces the cost of producing a large number of masters while maintaining high resolution surface patterns. Defining tracking features on a mastering bench provides master media with the track precision needed for high density data storage media, e.g., blue disks. Defining surface patterns on the master media in relatively inexpensive recording drives substantially reduces the cost of producing large numbers of data storage media relative to a conventional mastering bench. For example, a recording drive may cost approximately $2000 while a mastering bench may cost at least $1 million.

Furthermore, conventional mastering techniques may produce approximately 100,000 data storage media from a patterned master created on a mastering bench. The mastering techniques described herein may produce approximately 100,000 master media from a first generation master created on a mastering bench. Each of the master media may then be simultaneously patterned in a plurality of recording drives. Approximately 100,000 data storage media may be produced from each of the stampers created from the second generation masters. Thus, each first generation master may yield approximately 10,000,000,000 replica disks. In addition, each of the master media may be defined with a different surface pattern such that a large number of different second generation masters may be simultaneously produced. The cascading multiplication of stampers from a first generation master created on the mastering bench is a particularly desirable feature for parallel distribution of multiple media titles.

In some cases, the master media including the precise tracking features may be purchased such that a user can produce masters on recording drives without having to purchase a prohibitively expensive mastering bench. This may be especially useful for small recording studios and production companies that wish to create data storage media at a relatively low cost.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIGS. 1A and 1B illustrate a top view and a cross-sectional view of a master medium in accordance with an embodiment of the invention.

FIG. 2 is a block diagram illustrating a mastering bench that may be used to master a pre-master medium in accordance with embodiments of the invention.

FIGS. 3A and 3B are schematic diagrams illustrating a mastering technique for a pre-master medium.

FIG. 4 is a schematic diagram illustrating creation of a first stamper from a first generation master.

FIGS. 5A and 5B are schematic diagrams illustrating creation of a preformatted substrate from a first stamper.

FIG. 6 is a schematic diagram illustrating a portion of a master medium.

FIG. 7 is a block diagram illustrating an exemplary embodiment of a recording drive.

FIGS. 8A and 8B are schematic diagrams illustrating a recording drive mastering technique for a master medium in accordance with one embodiment of the invention.

FIGS. 9A and 9B are schematic diagrams illustrating a recording drive mastering technique for a master medium in accordance with another embodiment of the invention.

FIG. 10 is a schematic diagram illustrating creation of a second stamper from a second generation master.

FIGS. 11A and 11B are schematic diagrams illustrating creation of a data storage medium from a second stamper.

FIG. 12 is a flowchart illustrating a method of creating a plurality of data storage media from drive recordable master media.

FIG. 13 is a flowchart illustrating a method of defining a surface pattern on a master medium in a recording drive.

### DETAILED DESCRIPTION

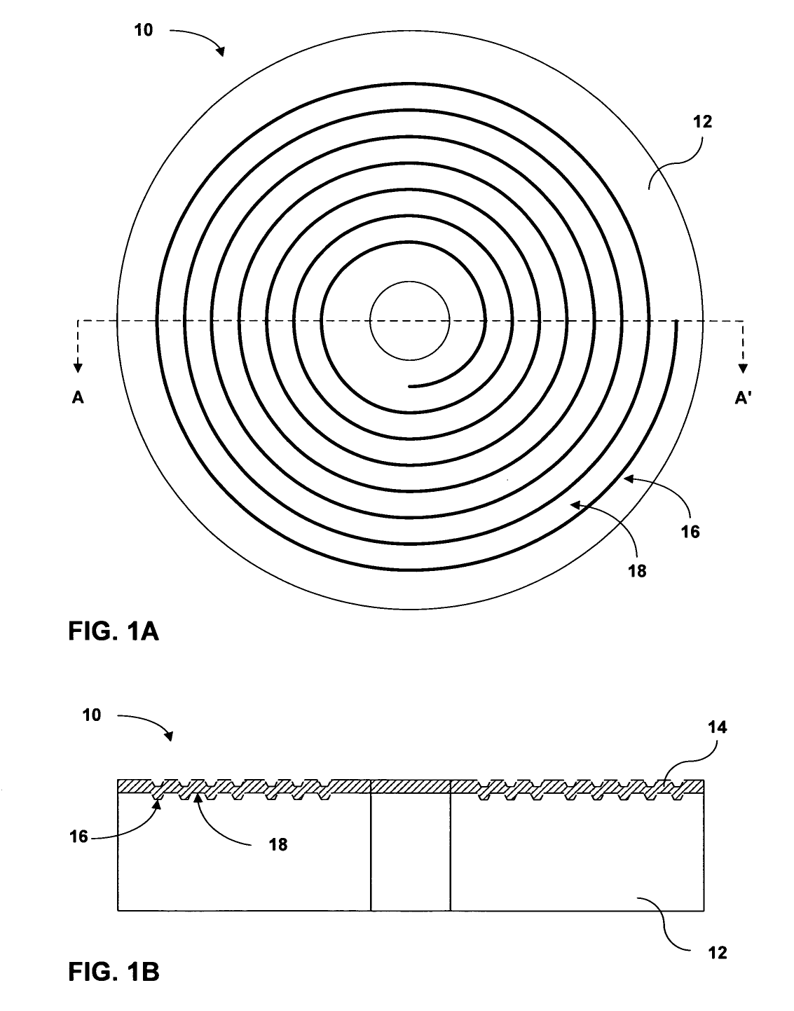

FIGS. 1A and 1B illustrate a top view and a cross-sectional view of a master medium 10 in accordance with an embodiment of the invention. Master medium 10 comprises a preformatted substrate layer 12 that includes tracking grooves 16 and a developable layer 14 formed over preformatted substrate layer 12. In other embodiments, one or more developable layers may be formed over substrate layer 12, as part of a tuned multi-layer thin film stack. In the illustrated embodiments, master medium 10 comprises a disk-shape. In other embodiments, master medium 10 may comprise non-disk shapes.

Substrate layer 12 may comprise glass, silicon, thermoplastic, or another substrate material of suitable optical surface quality. Substrate layer 12 is preformatted with tracking features including grooves 16 and lands 18. For example, a conventional mastering bench may precisely define tracking features on a pre-master medium. A stamper may comprise a surface pattern that is the inverse of the surface pattern encoded on the pre-master medium. An injection mold process or a photopolymer replication process can use the stamper to facilitate the creation of preformatted substrate layer 12 that includes tracking features 16 and 18.

As illustrated in the top view of FIG. 1A, tracking grooves 16 define a spiral pattern on substrate layer 12. In other embodiments, tracking grooves 16 may define a concentric circle pattern on substrate layer 12. In the case of a non-disk shaped master medium, the tracking features might alternatively traverse back and forth in prescribed patterns through a substrate of any desired shape.

Developable layer 14 may be formed over preformatted substrate layer 12 by a thin film deposition process or a spin-coating process. As shown in the cross-sectional view of FIG. 1 B, developable layer 14 conforms to tracking features 16 and 18. Developable layer 14 may comprise a phase-change material. A local amorphous/crystalline state of the phase-change material of developable layer 14 may be altered when exposed to light or heat above a threshold value. The phase-change material may provide better feature resolution than a conventional photoresist material. Alternately, developable layer 14 may comprise a thin film transition metal or a metal oxide such as iron, an iron oxide, nickel, chromium, or titanium.

In the case wherein master medium 10 includes more than one developable layer, a multi-layer thin film stack may be formed over preformatted substrate layer 12. A multi-layer stack coupled with a non-linear recording and developing process may improve feature resolution on master medium 10. For example, a multi-layer thin film stack that includes a substantially reflective layer is disclosed in copending and commonly assigned U.S. patent application Ser. No. 10/996,590, entitled “MULTI-LAYER OPTICAL DATA STORAGE DISK MASTERS,” to Jathan D. Edwards, filed Nov. 23, 2004, the entire content of which is incorporated herein by reference.

Master medium 10 may be inserted into a recording drive capable of following tracking features, e.g., either grooves 16 or lands 18. The recording drive may include an objective lens to focus a light onto developable layer 14 along tracking grooves 16. Alternatively, the recording drive may include an objective lens to focus a light onto developable layer 14 along tracking lands 18 interposed between tracking grooves 16. Illuminating developable layer 14 with sufficiently high power alters regions of developable layer 14. After removing master medium 10 from the recording drive, the altered regions of developable layer 14 may be developed to define a topographical surface pattern on master medium 10. In this way, a recording drive may create a master topography on master medium 10.

Master medium 10 may conform to a blue disk standard form factor. As used herein, the term blue disk refers to optical disk media having a data storage capacity of greater than 15 gigabyte (GB) per data storage layer of the disk. Examples of current blue disk media include Blu-Ray and HD-DVD, but other future generations of optical disks may also comprise blue disks. Master media 10 may have a diameter of approximately 120 mm and a thickness of approximately 1.2 mm including a cover layer. For example, a Blu-Ray standard form factor has a 0.1 mm thick coversheet bonded to a 1.1 mm thick substrate. An HD-DVD standard form factor has a 0.6 mm thick incident substrate bonded to another 0.6 mm thick substrate. However, in the illustrated embodiment, master medium 10 comprises a cover-less air incident medium. Therefore, master medium 10 may conform to a blue disk standard form factor without a cover layer.

The recording drive may comprise a blue disk recording drive, i.e., a disk drive that contains a blue-laser drive head, to define a high resolution surface pattern in master medium 10. A blue disk recording drive focuses a light onto developable layer 14 of master medium 10 via a cover layer either positioned adjacent developable layer 14 or affixed adjacent an objective lens within the recording drive. As described above, the cover layer may comprise a protective cover sheet with a thickness of approximately 0.1 mm for a Blu-Ray standard form factor or an incident substrate with a thickness of approximately 0.6 mm for an HD-DVD standard form factor.

Conventional mastering techniques may create approximately ten different masters on a mastering bench each day. Purchasing additional mastering benches to increase the number of different masters being produced may be prohibitively expensive as each mastering bench may cost at least $1 million. The techniques described herein can generate an essentially limitless number of different masters at a relatively low cost. The master media enable conventional recording drives to simultaneously define different surface patterns along the tracking features on the master media to create a plurality of different masters. In this way, the number of different masters may be increased by purchasing additional recording drives that each cost approximately $2000.

Defining tracking features on a mastering bench provides pre-master media with the track precision needed for high density data storage media, e.g., blue disks. Using the processes described herein, this pre-master media precision may be transferred to a plurality of drive recordable master media. Defining surface patterns on the master media in relatively inexpensive recording drives substantially reduces the cost of producing a large number of different masters. Dividing the roles of mechanical precision and fine feature definition means that a plurality of recording drives with capable servo systems can replicate the precision mechanics of a single conventional mastering bench.

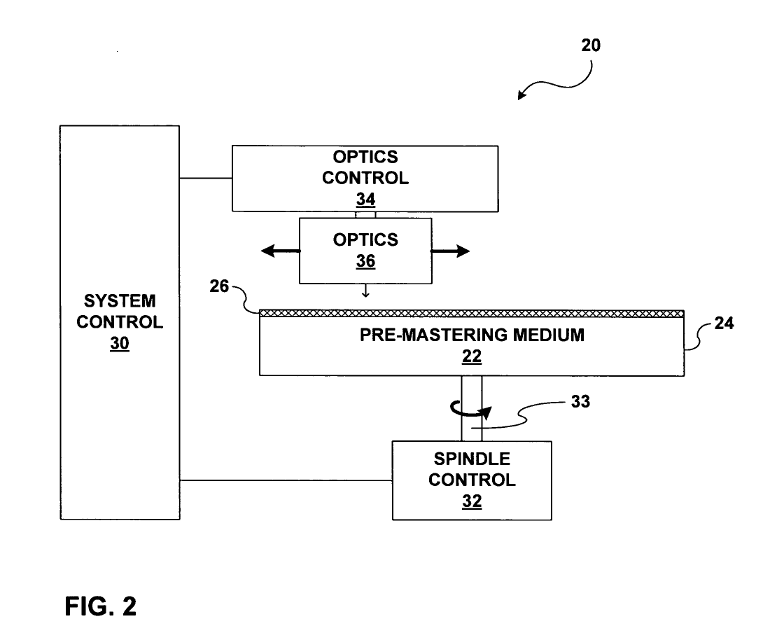

FIG. 2 is a block diagram illustrating a mastering bench 20 that may be used to master a pre-master medium 22 in accordance with embodiments of the invention. In general, mastering bench 20 defines precise tracking features, e.g., grooves and lands, on pre-master medium 22. Mastering bench 20 may comprise a conventional photoresist mastering bench. In other embodiments, mastering bench 20 may comprise a phase transition mastering (PTM) bench available from manufacturers such as SONY Corporation of Japan.

Mastering bench 20 includes a system control 30, such as a personal computer, workstation, or other computer system. System control 30, for example, may comprise one or more processors that execute software to provide user control over mastering bench 20. System control 30 provides commands to spindle control 32 and optics control 34 in response to user input. The commands sent from system control 30 to spindle control 32 and optics control 34 define the operation of mastering bench 20 during the tracking groove recording process.

Pre-master medium 22 may comprise a substrate layer 24 with a photoresist layer 26 positioned adjacent substrate layer 24. A spin coating process may apply photoresist layer 26 adjacent substrate layer 24. Substrate layer 24 may comprise glass, silicon, thermoplastic, or another substrate material of suitable optical surface quality. Photoresist layer 26 may comprise a positive photoresist material or a negative photoresist material. In some embodiments, more than one layer may be positioned adjacent substrate layer 24. In the case of a PTM bench, a transition metal layer may be deposited adjacent substrate layer 24 instead of photoresist layer 26.

Pre-master medium 22 is carefully placed in mastering bench 20 on spindle 33. Optics 36 may provide light with energy capable of photolithographically defining a region of photoresist layer 26, according to commands by system control 30. Spindle control 32 causes spindle 33 to spin pre-master medium 22, while optics control 34 controls the positioning of optics 36 relative to pre-master medium 22. As pre-master medium 22 spins on spindle 33, optics control 34 translates optics 36 to desired positions and causes optics 36 to emit light that defines regions of photoresist layer 26.

Optics 36 may provide light that illuminates regions of photoresist layer 26 to photolithographically define tracking features in a prescribed pattern, e.g., a spiral pattern or a concentric circle pattern. Illuminating regions of photoresist layer 26 may include exposing layer 26 with a focused laser spot from optics 36. In some cases, the focused laser spot may utilize tip recording to increase the resolution of the photolithographically defined tracking grooves. In the case of a PTM bench, the light from optics 36 may induce changes in the transition metal layer.

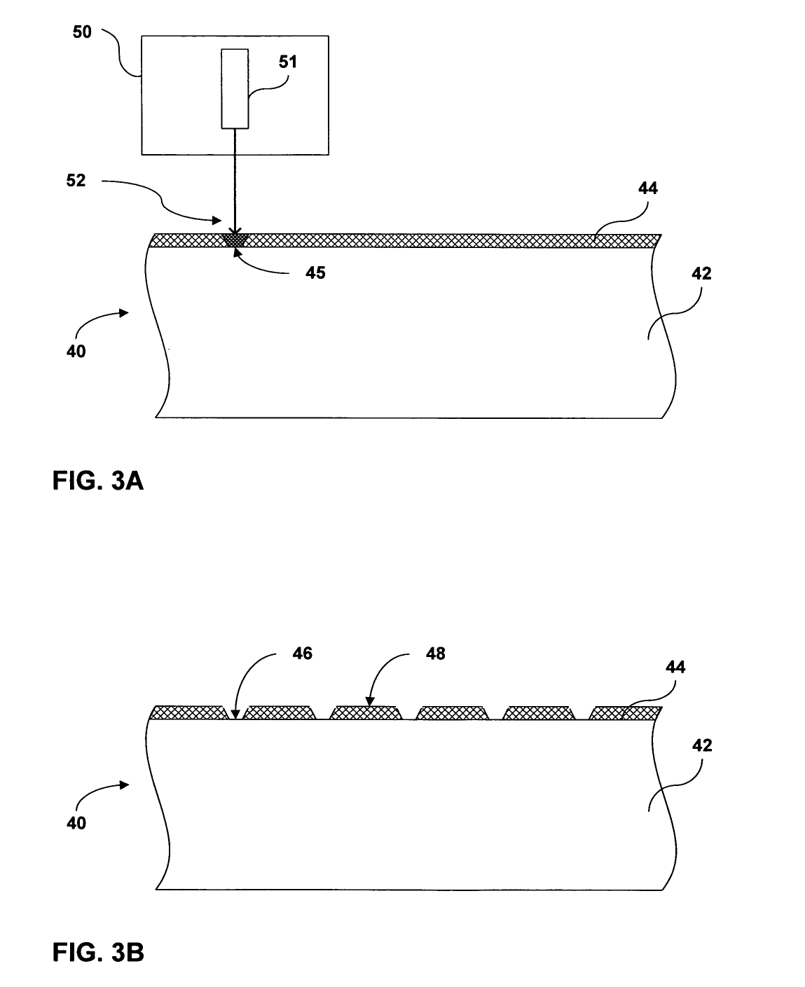

FIGS. 3A and 3B are schematic diagrams illustrating a mastering technique for a pre-master medium 40. Pre-master medium 40 includes a substrate layer 42 and a photoresist layer 44 positioned adjacent substrate layer 42. Substrate layer 42 may comprise glass, silicon, or thermoplastic. Regions of photoresist layer 44 may be photolithographically defined when illuminated by a focused laser spot. The defined regions may then be removed by applying a developer solution to photoresist layer 44. The illustrated technique includes defining precision tracking features in pre-master medium 40 by developing photolithographically defined regions 45 of photoresist layer 44. In other cases, a transition metal layer may be deposited adjacent substrate layer 44. Regions of the transition metal layer may be altered when exposed to light or heat above a threshold value.

FIG. 3A illustrates a portion of pre-master medium 40 being illuminated by optics 50, which may operate substantially similar to optics 36 in FIG. 2. Optics 50 includes a laser 51 that produces a light used to create a precisely focused laser spot 52. Optics 50 illuminates photoresist layer 44 of pre-master medium 40 with focused laser spot 52. Illuminating photoresist layer 44 with laser spot 52 photolithographically defines a region 45 of photoresist layer 44. Region 45 may correspond to a tracking groove of pre-master medium 40. As described herein, tracking features, such as grooves and lands, are defined in pre-master medium 40 to create preformatted substrate layers for drive recordable master media.

Optics 50 may then be translated in either a continuous manner for a spiral pattern or in discrete steps relative to pre-master medium 40 so that during a subsequent pass, focused laser spot 52 photolithographically defines a different region of photoresist layer 44. In this way, tracking grooves may be photolithographically defined in a prescribed pattern on pre-master medium 40.

In some cases, optics 50 may define multiple laser spots or interferometric laser spots. Multiple passes of the focused laser spots or constructive interference fringes can be made relative to pre-master medium 40 so as to alter regions of photoresist layer 44 of pre-master medium 40. The multiple or interferometric laser spots may improve consistency in the features defined on pre-master medium 40 and improve track pitch variation. Multiple and interferometric mastering techniques are disclosed in copending and commonly assigned U.S. patent application Ser. No. 10/807,822, titled “MULTI-TRACK MASTERING TECHNIQUES,” to Jathan Edwards, filed Mar. 24, 2004, the entire content of which is incorporated herein by reference.

FIG. 3B illustrates the portion of pre-master medium 40 with regions 45 of photoresist layer 44 developed, i.e., a first generation master. A developer solution may be applied to photoresist layer 44 to remove photolithographically defined regions 45 from pre-master medium 40. For example, the developer solution may comprise sodium hydroxide (NaOH) or potassium hydroxide (KOH). Developing regions 45 of photoresist layer 44 physically defines regions 46 and regions 48 in photoresist layer 44. Regions 46 correspond to tracking grooves and regions 48 correspond to tracking lands of the first generation master.

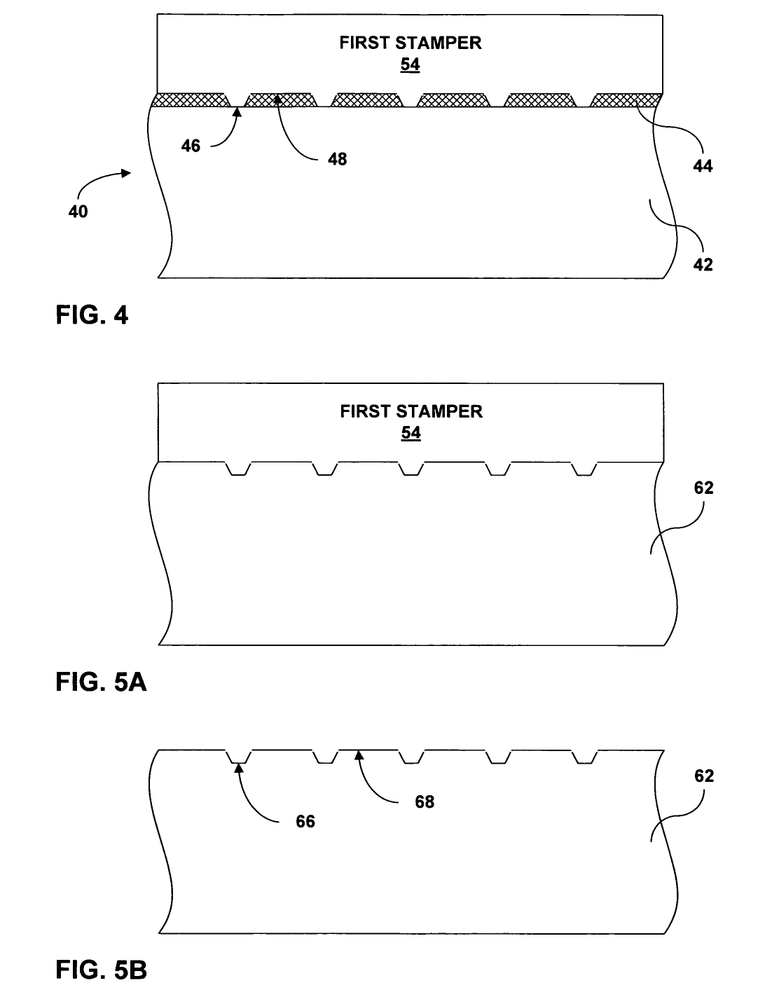

FIG. 4 is a schematic diagram illustrating creation of a first stamper 54 from the first generation master, i.e., patterned pre-master medium 40. After formatting pre-master medium 40 (illustrated in FIGS. 3A and 3B), the first generation master is used to create first stamper 54. First stamper 54 is less fragile than pre-master medium 40 such that first stamper 54 is strong enough to create a plurality of high resolution replications.

First stamper 54 may be formed of electroplated metal or a hard plastic material. When applied to formatted pre-master medium 40, the material of first stamper 54 conforms to regions 46 and regions 48 in photoresist layer 44 of pre-master medium 40. In the illustrated embodiment, first stamper 54 has a surface pattern that is an inverse of the surface pattern formed by regions 46 and 48 on pre-master medium 40. In other words, first stamper 54 comprises a surface pattern that is the inverse of the tracking features defined in the first generation master.

FIGS. 5A and 5B are schematic diagrams illustrating creation of a preformatted substrate 62 from first stamper 54. Substrate 62 may comprise glass, silicon, or thermoplastic. Preferably substrate 62 comprises injection molded thermoplastic. First stamper 54 formats substrate 62 with tracking features from the first generation master, i.e., formatted pre-master medium 40, such that preformatted substrate 62 may be used to form a master medium substantially similar to master medium 10 from FIG. 1. First stamper 54 may create a plurality of preformatted substrates. For example, first stamper 54 may create at least 100,000 preformatted substrates that include precision tracking features.

As illustrated in FIG. 4, first stamper 54 comprises a surface pattern that is the inverse of the tracking features defined on pre-master medium 40. When first stamper 54 is applied to a substrate 62, the material of substrate 62 conforms to the surface pattern of first stamper 54. In this way, first stamper 54 defines regions 66 and regions 68 in substrate 62. Preformatted substrate 62 has a surface pattern that is the inverse of the surface pattern of first stamper 54 and is a replica of the surface pattern of pre-master medium 40. Regions 66 of preformatted substrate 62 correspond to tracking grooves and regions 68 of preformatted substrate 62 correspond to tracking lands.

In some cases an injection mold process may use first stamper 54 to create preformatted substrate 62. In other cases, a photopolymer replication process can use first stamper 54 to create preformatted substrate 62. For example, a photopolymer may be applied to substrate 62 and first stamper 54 may be rolled across the photopolymer in a rolling bead process. A light then shines through first stamper 54 and the photopolymer to define regions 66 and 68. The photopolymer is pealed off of substrate 62 to reveal the surface pattern.

In other embodiments, a surface pattern encoded on a pre-master medium represents an inverse of the desired tracking feature pattern. In those cases, the first generation master is typically used to create a first-generation stamper, which is in turn used to create a second-generation stamper. The second-generation stamper can be used to create preformatted substrates that contain an inverse of the surface pattern encoded on the pre-master medium, i.e., a surface pattern that corresponds to tracking features. Creating multiple generations of stampers can also allow for improved preformatted substrate productivity from a single pre-master medium.

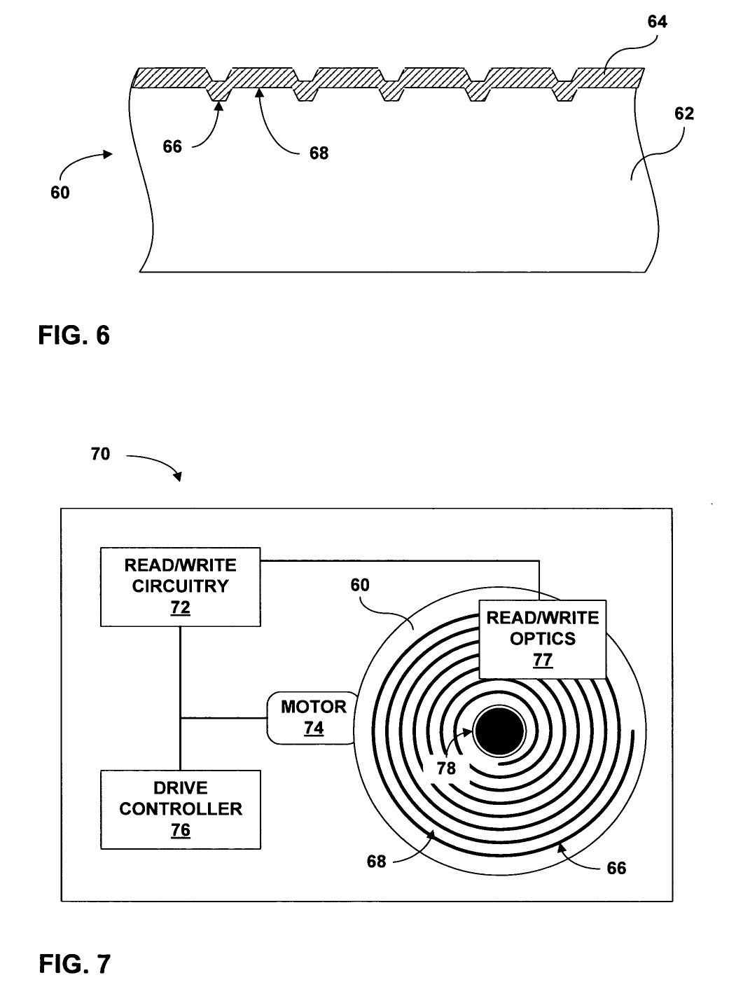

FIG. 6 is a schematic diagram illustrating a portion of a master medium 60. Master medium 60 may be substantially similar to master medium 10 from FIG. 1. Master medium 60 comprises preformatted substrate layer 62 created from first stamper 54. Preformatted substrate layer 62 includes regions 66 and 68 that correspond to tracking grooves and tracking lands, respectively. Master medium 60 also comprises a developable layer 64 formed over preformatted substrate layer 62. In other embodiments, more than one developable layer may be formed over substrate layer 62 or developable layer 64 may be part of a tuned multi-layer thin film stack formed over substrate layer 62.

Developable layer 64 may be formed over preformatted substrate layer 62 by a thin film deposition process or a spin-coating process. Developable layer 64 fills tracking grooves 66. Developable layer 64 may comprise a phase-change material wherein a local amorphous/crystalline state of the phase-change material of developable layer 64 may be altered when exposed to light or heat above a threshold value. The phase-change material may provide better feature resolution than a photoresist material used in conventional mastering techniques. Alternatively, developable layer 64 may comprise a thin film transition metal or a metal oxide such as iron, an iron oxide, nickel, chromium, or titanium.

Master medium 60 may conform to a blue disk standard form factor, such as a Blu-Ray standard form factor or an HD-DVD standard form factor. In this illustrated embodiment, master medium 60 comprises an air incident medium that does not include a cover layer. Although the blue disk standards include cover layers with specific thicknesses, the cover layers may be affixed adjacent an objective lens within a recording drive instead of adjacent developable layer 64. In the case of an air-incident Blu-Ray standard form factor, master medium 60 may have a diameter of approximately 120 mm and a thickness of approximately 1.1 mm. In the case of an air-incident HD-DVD standard form factor, master medium 60 may have a diameter of approximately 120 mm and a thickness of approximately 0.6 mm.

FIG. 7 is a block diagram illustrating an exemplary embodiment of a recording drive 70. Recording drive 70 is capable of accurately following tracking features, such as tracking grooves 66 or tracking lands 68 defined on master medium 60. In other words, recording drive 70 includes a servo system capable of replicating the precision mechanics of a mastering bench, substantially similar to mastering bench 20 from FIG. 2. Recording drive 70 may comprise a conventional optical disk recording drive, e.g., a CD, DVD, or blue disk recording drive.

Recording drive 70 receives master medium 60 and positions master medium 60 on a spindle 78 within recording drive 70. Recording drive 70 includes read/write circuitry 72, a spindle motor 74, a drive controller 76, and read/write optics 77. Spindle motor 74 rotates master medium 60 around spindle 78. Drive controller 76 controls read/write circuitry 72, which in turn positions and controls read/write optics 77. Read/write optics 77 may include one or more lasers, one or more photosensitive elements, and various optical conditioning elements that facilitate optical data storage and readout. In some cases, firmware changes may be made to recording drive 70 to define operation of read/write optics 77. For example, the operation of read/write optics 77 may be adjusted to accommodate format differences between read-only memory (ROM) media and recordable media.

Read/write optics 77 may comprise a light source and an objective lens to focus the light onto developable layer 64 of master medium 60 along the tracking features, i.e., grooves 66 or lands 68. For example, the focused light, e.g., a focused laser spot, illuminates master medium 60 to alter regions of developable layer 64 along tracking grooves 66. Alternatively, the focused light may illuminate master medium 60 to alter regions of developable layer 64 along tracking lands 68 interposed between adjacent tracking grooves 66. In following the precision tracking grooves 66 or lands 68, the focused light may be modulated or wobbled to define information in the altered regions. After removing master medium 60 from recording drive 70, the altered regions of developable layer 64 may be developed to define a topographical surface pattern on master medium 60. Developing the altered regions may comprise applying a solution, such as diluted NaOH, or a vacuum removal process, such as a Reactive Ion Etch (RIE) process, to developable layer 64. In this way, recording drive 70 may create a master topography on master medium 60.

Recording drive 70 may comprise a blue disk recording drive in which read/write optics 77 contains a blue-laser drive head. The blue-laser drive head enables recording drive 70 to define higher resolution features on a blue laser compatible master medium. As described above, master medium 60 may conform to a blue disk standard form factor. In this case, recording drive 70 focuses a light onto developable layer 64 of master medium 60 via a cover layer.

The cover layer may comprise a protective coversheet with a thickness of approximately 0.1 mm for a Blu-Ray standard form factor or an incident substrate with a thickness of approximately 0.6 mm for an HD-DVD standard form factor. In some cases, the cover layer may be releasably bonded to developable layer 64 of master medium 60. The cover layer may then be removed prior to developing the altered regions of developable layer 64. In other cases, the cover layer may be affixed adjacent the objective lens within read/write optics 77 of recording-drive 70.

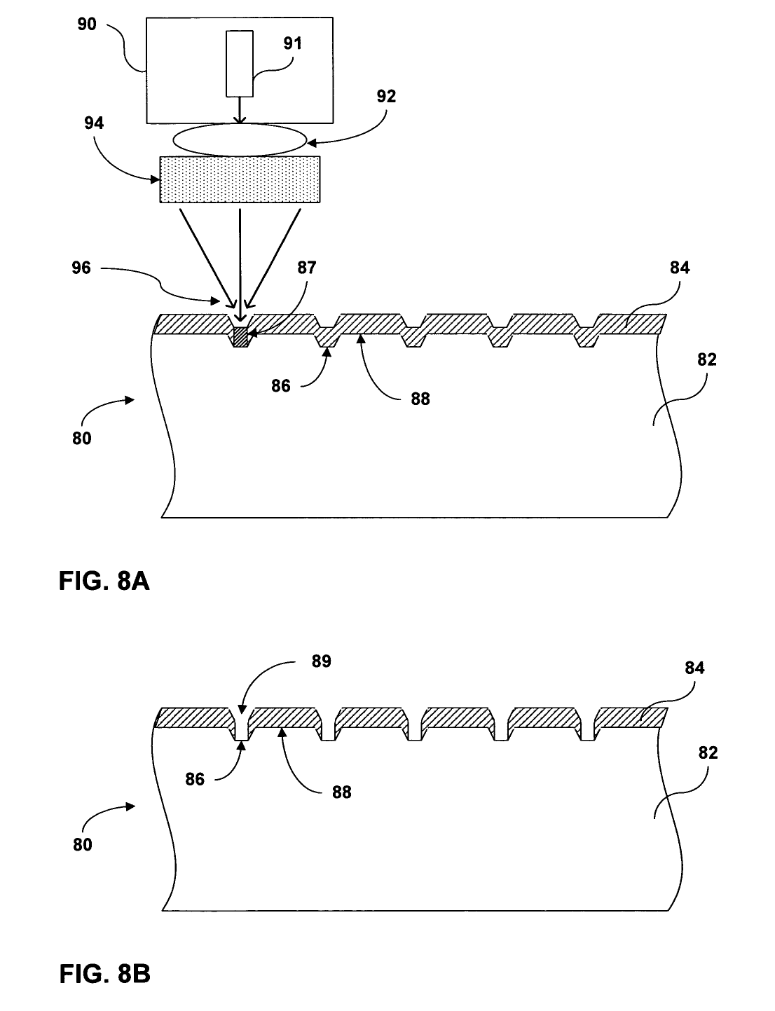

FIGS. 8A and 8B are schematic diagrams illustrating a recording drive mastering technique for a master medium 80 in accordance with one embodiment of the invention. Master medium 80 may be substantially similar to master medium 10 of FIG. 1 or master medium 60 of FIG. 6. Master medium 80 includes a preformatted substrate layer 82 and a developable layer 84 formed over preformatted substrate layer 82. Preformatted substrate layer 82 may comprise glass, silicon, or preferably injection molded thermoplastic. Developable layer 84 may comprise a phase-change material. Alternatively, developable layer 84 may comprises a thin film transition metal or a metal oxide.

Preformatted substrate layer 82 includes precision tracking grooves 86 and precision tracking lands 88. As described above, substrate layer 82 may be formatted using a stamper formed from a first generation master, i.e., a pre-master medium, with tracking features defined by a conventional mastering bench. Regions of developable layer 84 may alter when exposed to light or heat above a threshold value. The altered regions may then be removed by applying a developer solution to developable layer 84. Alternatively, the developing step may utilize a vacuum removal process such as RIE. The illustrated technique includes defining a surface pattern on master medium 80 by developing altered regions 87 of developable layer 84.

FIG. 8A illustrates a portion of master medium 80 being illuminated by read/write optics 90, which may operate substantially similar to read/write optics 77 in FIG. 7. Read/write optics 90 may be contained within a recording drive. Read/write optics 90 includes a laser 91 and an objective lens 92 that focuses light produced by laser 91 through cover layer 94 to create a precisely focused laser spot 96.

In the illustrated embodiment, master medium 80 comprises a cover-less air incident medium, and cover layer 94 is affixed adjacent objective lens 92 of read/write optics 90. In this way, read/write optics 90 can illuminate developable layer 84 with focused laser spot 96 without bonding a cover layer adjacent developable layer 84. Therefore, developable layer 84 of master medium 80 may be developed without first having to remove a cover layer.

Master medium 80 may conform to a blue disk standard form factor. For example, master medium 80 may conform to a cover-less Blu-Ray standard form factor with a thickness of approximately 1.1 mm. In other cases, master medium 80 may conform to a cover-less HD-DVD standard form factor with a thickness of approximately 0.6 mm. In order to focus light produced by laser 91 onto a surface of developable layer 84, the blue disk standard form factors require a specific thickness of cover layer 94. In the case of the Blu-Ray standard form factor, cover layer 94 has a thickness of approximately 0.1 mm. In the case of the HD-DVD standard form factor, cover layer 94 has a thickness of approximately 0.6 mm.

Read/write optics 90 illuminates developable layer 84 of master medium 80 via cover layer 94 with focused laser spot 96. Illuminating developable layer 84 with laser spot 96 alters a region 87 of developable layer 84. Altered region 87 may correspond to a feature of master medium 80. In the illustrated embodiment, the recording drive that includes read/write optics 90 accurately follows tracking grooves 86 such that features are defined in master medium 80 along tracking grooves 86 to create a high resolution master for data storage media. In other embodiments, a recording drive that includes read/write optics 90 may follow tracking lands 88 interposed between adjacent tracking grooves 86 in order to define features in master medium 80 along tracking lands 88.

Read/write optics 90 may be translated in either a continuous manner for a spiral pattern or in discrete steps relative to tracking grooves 86 of master medium 80 so that during a subsequent pass, focused laser spot 96 alters a different region of developable layer 84 along tracking grooves 86. Once read/write optics 90 has formatted a desired surface pattern on master medium 80, master medium 80 is removed from the recording drive.

FIG. 8B illustrates the portion of master medium 80 with altered regions 87 of developable layer 84 developed, i.e., a second generation master. A developer solution may be applied to developable layer 84 to remove altered regions 87 from master medium 80. For example, the developer solution may comprise sodium hydroxide (NaOH) or potassium hydroxide (KOH). Alternatively, the development step may include a vacuum removal process, such as RIE. Developing altered regions 87 of developable layer 84 physically defines regions 89 in developable layer 84. Regions 89 correspond to features of the second generation master that create the desired surface pattern.

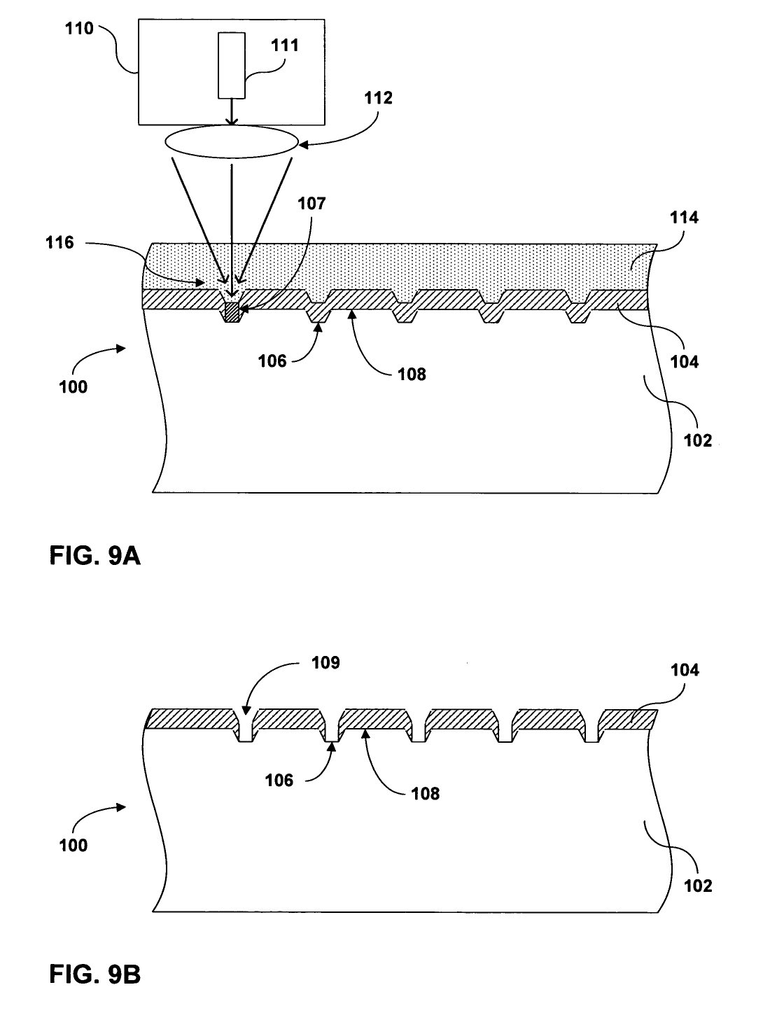

FIGS. 9A and 9B are schematic diagrams illustrating a recording drive mastering technique for a master medium 100 in accordance with another embodiment of the invention. Master medium 100 includes a preformatted substrate layer 102, a developable layer 104 formed over preformatted substrate layer 102, and a cover layer 114 releasably bonded to developable layer 104. Preformatted substrate layer 102 may comprise glass, silicon, or preferably an injection molded thermoplastic. Developable layer 104 may comprise a phase-change material. Alternatively, developable layer 104 may comprise a thin film transition metal or a metal oxide.

Preformatted substrate layer 102 includes precision tracking grooves 106 and precision tracking lands 108. As described above, substrate layer 102 may be formatted using a stamper formed from a first generation master, i.e., a pre-master medium, with tracking features defined by a conventional mastering bench. Regions of developable layer 104 may alter when exposed to light or heat above a threshold value. The altered regions may then be removed by first removing cover layer 114 and then applying a developer solution to developable layer 104. Alternatively, the development process may include a vacuum removal process such as RIE. The illustrated technique includes defining a surface pattern on master medium 100 by developing altered regions 107 of developable layer 104.

FIG. 9A illustrates a portion of master medium 100 being illuminated by read/write optics 110, which may operate substantially similar to read/write optics 77 in FIG. 7. Read/write optics 110 may be contained within a conventional recording drive. Read/write optics 110 includes a laser 111 and an objective lens 112 that focuses light produced by laser 111 to create a precisely focused laser spot 116.

Master medium 100 may conform to a blue disk standard form factor. For example, master medium 100 may conform to a Blu-Ray standard form factor with a thickness of approximately 1.1 mm. In order to focus light onto a surface of developable layer 104, the Blu-Ray standard form factor requires cover layer 114, i.e., a protective coversheet, to have a thickness of approximately 0.1 mm. In other cases, master medium 100 may conform to an HD-DVD standard form factor with a thickness of approximately 0.6 mm that requires cover layer 114, i.e., an incident substrate, to have a thickness of approximately 0.6 mm.

Read/write optics 110 illuminates developable layer 104 of master medium 100 via cover layer 114 with focused laser spot 116. Illuminating developable layer 104 with laser spot 116 alters a region 107 of developable layer 104. Altered region 107 may correspond to a feature of master medium 100. In the illustrated embodiment, the recording drive that includes read/write optics 110 accurately follows tracking grooves 106 such that features are defined in master medium 100 along tracking grooves 106 to create a high resolution master for data storage media. In other embodiments, a recording drive that includes read/write optics 110 may follow tracking lands 108 interposed between adjacent tracking grooves 106 in order to define features in master medium 100 along tracking lands 108.

Read/write optics 100 may be translated in either a continuous manner for a spiral pattern or in discrete steps relative to tracking grooves 106 of master medium 100 so that during a subsequent pass, focused laser spot 116 alters a different region of developable layer 104 along tracking grooves 106. Once read/write optics 110 has formatted a desired surface pattern on master medium 100, master medium 100 is removed from the recording drive.

FIG. 9B illustrates the portion of master medium 100 with altered regions 107 of developable layer 104 developed, i.e., a second generation master. As described above, cover layer 114 is releasably bonded to developable layer 104. For example, a releasable adhesive may be used to affix cover layer 114 adjacent developable layer 104 in order to master the medium 100 in a conventional recording drive. Cover layer 114 may be removed from developable layer 104 by simply applying force or a solution to release the adhesive.

A developer solution may then be applied to developable layer 104 to remove altered regions 107 from master medium 100. For example, the developer solution may comprise sodium hydroxide (NaOH) or potassium hydroxide (KOH). Alternatively, the development process may include a vacuum removal process such as RIE. Developing altered regions 10.7 of developable layer 104 physically defines regions 109 in developable layer 104. Regions 109 correspond to features of the second generation master that create the desired surface pattern.

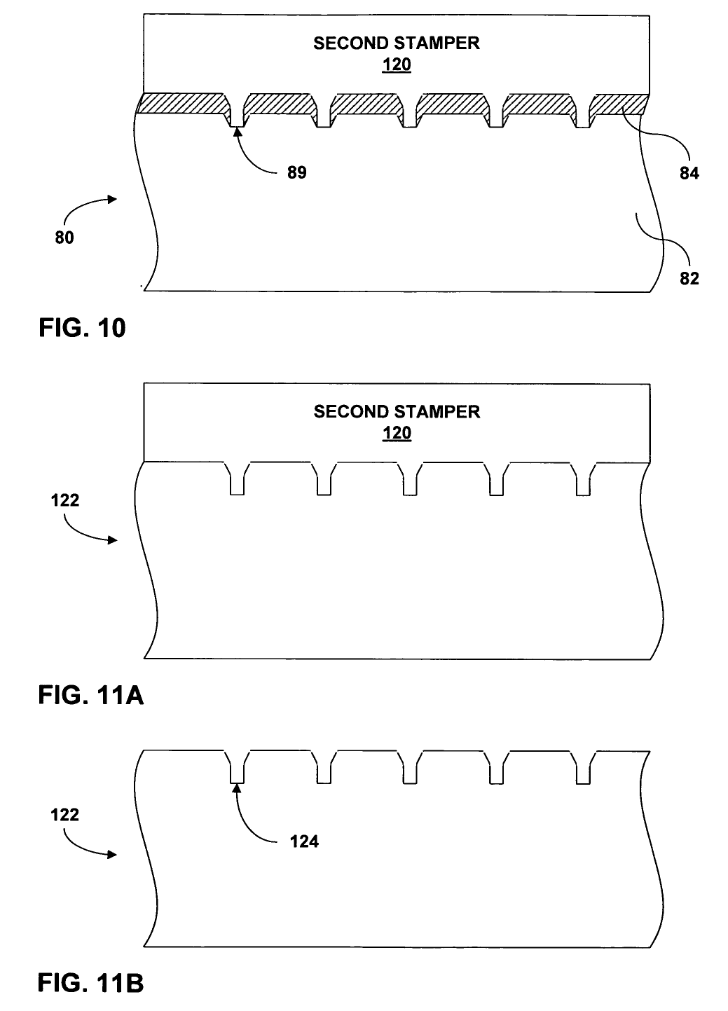

FIG. 10 is a schematic diagram illustrating creation of a second stamper 120 from the second generation master, i.e., patterned master medium 80. After defining a surface pattern on master medium 80 (illustrated in FIGS. 8A and 8B), the second generation master is used to create second stamper 120. Second stamper 120 is less fragile than master medium 80 such that second stamper 120 is strong enough to create a plurality of high resolution replications.

Second stamper 120 may be formed of electroplated metal or a hard plastic material. When applied to formatted master medium 80, the material of second stamper 120 conforms to regions 89 in developable layer 84 of master medium 80. In the illustrated embodiment, second stamper 120 has a surface pattern that is an inverse of the surface pattern formed on the second generation master.

FIGS. 11A and 11B are schematic diagrams illustrating creation of a data storage medium 122 from second stamper 120. Data storage medium 122 may comprise glass, silicon, or thermoplastic. Second stamper 120 formats data storage medium 122 with a surface pattern from the second generation master, i.e., patterned master medium 80. Second stamper 120 may create a plurality of data storage media. For example, second stamper 120 may create at least 100,000 data storage media that include the surface pattern from master medium 80.

As illustrated in FIG. 10, second stamper 120 comprises a surface pattern that is the inverse of the surface pattern defined on the second generation master. When second stamper 120 is applied to a data storage medium 122, the material of data storage medium 122 conforms to the surface pattern of second stamper 120. In this way, second stamper 120 defines regions 124 in data storage medium 124. Data storage medium 122 has a surface pattern that is the inverse of the surface pattern of second stamper 120 and is a replica of the surface pattern of the second generation master. Regions 124 of data storage medium 122 correspond to regions 89 of master medium 80. In addition, data storage medium 122 may be coated with a reflective layer and/or a phase-change layer, and sealed with an additional protective layer.

In some cases, an injection mold process may use second stamper 120 to create data storage medium 122. In other cases, a photopolymer replication process can use second stamper 120 to create data storage medium 122. For example, a photopolymer may be applied to data storage medium 122 and second stamper 120 may be rolled across the photopolymer in a rolling bead process. A light then shines through second stamper 120 and the photopolymer to define regions 124. The photopolymer is pealed off of data storage medium 122 to reveal the surface pattern, which corresponds to features of the second generation master. Data storage medium 122 may comprise a blue disk, such as a Blu-Ray disk or an HD-DVD disk.

In other embodiments, a surface pattern encoded on a master medium represents an inverse of the desired replica surface pattern. In those cases, the second generation master is typically used to create a first-generation stamper, which is in turn used to create a second-generation stamper. The second-generation stamper can be used to create data storage media that contain an inverse of the surface pattern encoded on the master medium. Creating multiple generations of stampers can also allow for improved preformatted substrate productivity from a single master medium.

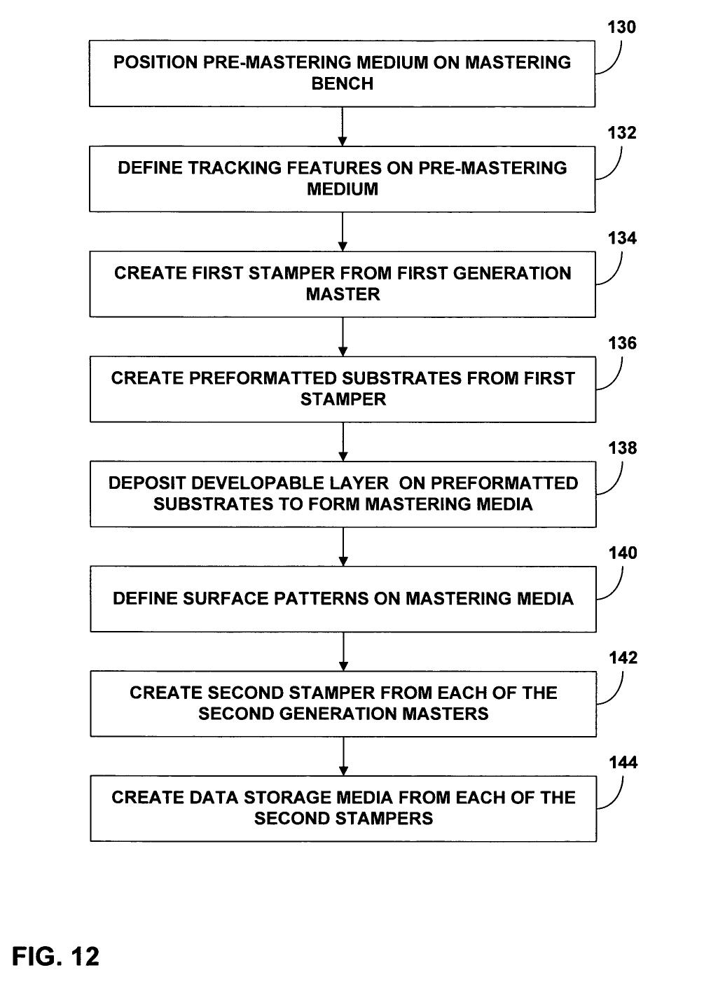

FIG. 12 is a flowchart illustrating a method of creating a plurality of data storage media from drive recordable master media. A pre-master medium is positioned on a mastering bench (130). The pre-master medium may comprise a substrate layer and a photoresist layer formed over the substrate layer. The mastering bench may be substantially similar to mastering bench 20 illustrated in FIG. 2. In some cases, the mastering bench may comprise a PTM bench. The mastering bench defines precision tracking features on the pre-master medium (132).

A first stamper is then created from the formatted pre-master medium, i.e., a first generation master (134). The first stamper includes a surface pattern that is the inverse of the tracking grooves defined on the pre-master medium. The first stamper then creates a plurality of preformatted substrates (136). For example, the first stamper may create at least 100,000 preformatted substrates. When the first stamper is applied to one of the substrates, the material of the substrate conforms to the surface pattern of the first stamper. The preformatted substrates have surface patterns that are the inverse of the surface pattern of the first stamper and replicas of the tracking features of the first generation master.

At least one developable layer is formed over each of the preformatted substrates to form a plurality of master media (138). In some cases the at least one developable layer may be included in a tuned multi-layer thin film stack. Topographical surface patterns may then be defined on the master media (140). The surface patterns are defined by altering regions of the developable layer in recording drives and developing the altered regions. In this way, a large number of different surface patterns may be simultaneously defined on the master media. The recording drives may comprise conventional CD, DVD, or blue disk recording drives.

A second stamper is then created from each of the plurality of formatted master media, i.e., second generation masters (142). The second stamper includes a surface pattern that is the inverse of the surface pattern defined on the master medium. Each of the second stampers then creates a plurality of data storage media (144). For example, each of the second stampers may create at least 100,000 data storage media. When the second stamper is applied to one of the data storage media, the material of the data storage medium conforms to the surface pattern of the second stamper. The data storage media have surface patterns that are the inverse of the surface pattern of the second stamper and replicas of the surface pattern of the second generation master. The data storage media may comprise blue disks, such as Blu-Ray disks or HD-DVD disks.

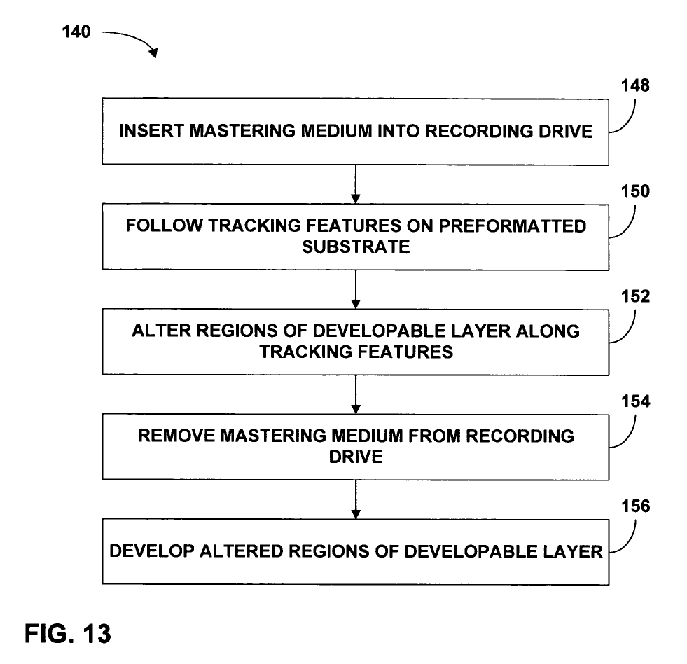

FIG. 13 is a flowchart illustrating a method of defining a surface pattern on a master medium in a recording drive. The method further describes step (140) of the method illustrated in FIG. 12. The method will be described herein in reference to FIGS. 8A and 8B. Master medium 80 comprises a cover-less air incident medium. The method may also be applied to master media that include cover layers, such as master medium 100 from FIGS. 9A and 9B.

Master medium 80 is inserted into a recording drive (148). The recording drive follows tracking features, e.g., tracking grooves 86, defined on preformatted substrate layer 82 of master medium 80 (150). In other embodiments, the recording drive may follow tracking lands 88. As the recording drive follows tracking grooves 86, read/write optics 90 illuminates developable layer 84 of master medium 80 via cover layer 94 with focused laser spot 96. Illuminating developable layer 84 with laser spot 96 alters regions 87 of developable layer 84 along tracking grooves 86 (152). Altered regions 87 may correspond to a desired surface pattern of master medium 80.

Master medium 80 is then removed from the recording drive (154). Altered regions 87 of developable layer 84 are developed (156). For example, a developer solution may be applied to developable layer 84 to remove altered regions 87 from master medium 80. In other cases, a developer process, such as RIE, may be applied to developable layer 84. Developing altered regions 87 of developable layer 84 defines the desired surface pattern on master medium 80 to form a second generation master. In the case of a master medium that includes a releasable cover layer, as illustrated in FIGS. 9A and 9B, the cover layer is removed prior to developing the altered regions of the developable layer.

Various embodiments of the invention have been described. For example, a master medium has been described that includes a preformatted substrate layer with tracking features and at least one developable layer formed over the preformatted substrate layer. In addition, a mastering technique has been described that combines mechanical precision from tracking features defined by a mastering bench with fine feature definition from surface patterns defined by recording drives capable of following the tracking features. In this way, the mastering technique provides a low cost method of creating a large number of high resolution masters.

For example, the mastering techniques described herein may produce approximately 100,000 master media from a first generation master created on a mastering bench. Each of the master media may then be simultaneously patterned in a plurality of recording drives. Approximately 100,000 data storage media may be produced from each of the patterned master media, i.e., second generation masters. In addition, each of the master media may be defined with a different surface pattern such that a large number of different masters may be simultaneously produced.

Furthermore, the master media including the precise tracking features may be purchased such that a user can produce masters on recording drives without having to purchase a prohibitively expensive mastering bench. This may be especially useful for small recording studios and production companies that wish to create data storage media at a relatively low cost. These and other embodiments may be within the scope of the following claims.

1. A master medium that defines a surface pattern, the master medium comprising:
a preformatted substrate layer including tracking features; and
at least one developable layer formed over the preformatted substrate layer, wherein the at least one developable layer is altered along the tracking features and developed to define the surface pattern.

2. The master medium of claim 1, further comprising a cover layer releasably bonded to the at least one developable layer.

3. The master medium of claim 1, wherein the preformatted substrate layer comprises one of glass, silicon, or thermoplastic.

4. The master medium of claim 1, wherein the tracking features comprise grooves-and lands.

5. The master medium of claim 1, wherein the at least one developable layer comprises one of a phase-change material, a transition metal, or a metal oxide.

6. The master medium of claim 1, wherein the master medium conforms to a blue disk standard form factor.

7. A method of mastering a master medium, wherein the master medium comprises a preformatted substrate layer including tracking features, and at least one developable layer formed over the preformatted substrate layer, the method comprising:
following the tracking features on the preformatted substrate;
altering regions of the at least one developable layer along the tracking features; and
developing the altered regions of the at least one developable layer to define a surface pattern on the master medium.

8. The method of claim 7, wherein altering regions of the at least one developable layer comprises illuminating the regions with a focused laser spot.

9. The method of claim 7, further comprising inserting the master medium into a recording drive capable of following the tracking features.

10. The method of claim 9, wherein the master medium includes a releasable cover layer and the recording drive includes an objective lens, altering regions of the at least one developable layer comprises focusing a light with the objective lens onto the at least one developable layer through the releasable cover layer.

11. The method of claim 9, wherein the master medium does not include a cover layer and the recording drive includes an objective lens, altering regions of the at least one developable layer comprises focusing a light with the objective lens onto the at least one developable layer through a cover layer affixed adjacent the objective lens.

12. The method of claim 7, wherein the master medium comprises a releasable cover layer, further comprising removing the releasable cover layer prior to developing the altered regions of the at least one developable layer.

13. The method of claim 7, wherein developing the altered regions comprises applying one of a developer solution or an etching process to the at least one developable layer to remove the altered regions from the at least one developable layer.

14. The method of claim 7, further comprising creating a stamper from the master medium, wherein the stamper includes a surface pattern that is the inverse of the surface pattern defined on the master medium.

15. The method of claim 14, further comprising creating a plurality of data storage media from the stamper, wherein each of the plurality of data storage media includes a replica of the surface pattern defined on the master medium.

16. The method of claim 15, wherein the plurality of data storage media comprise blue disks.

17. The method of claim 16, wherein the blue disks comprise one of a Blu-Ray disk or an HD-DVD disk.

18. A method comprising:
defining tracking features on a pre-master medium to form a first generation master;
creating a first stamper from the first generation master;
creating a plurality of preformatted substrates that include the tracking features from the first stamper;
forming at least one developable layer over each of the plurality of preformatted substrates to form a plurality of master media;
defining surface patterns on the plurality of master media to form a plurality of second generation masters;
creating a set of second stampers from the plurality of second generation masters; and
creating a plurality of data storage media from the second stampers.

19. The method of claim 18, wherein defining tracking features on the pre-master medium comprises positioning the pre-master medium on a mastering bench.

20. The method of claim 18, wherein forming the plurality of second generation masters comprises:
inserting the plurality of master media into recording drives;
following the tracking features on the preformatted substrates;
altering regions of the at least one developable layers along the tracking features; and
developing the altered regions of the at least one developable layers.
